(19) United States
(12) Patent Application Publication
(10) Pub. No.: US 2018/0183727 A1
(43) Pub. Date: Jun. 28, 2018

(54) TRAFFIC MAPPING OF A NETWORK ON CHIP THROUGH MACHINE LEARNING

(71) Applicant: NetSpeed Systems, Inc., San Jose, CA (US)

(72) Inventors: Sailesh KUMAR, San Jose, CA (US); Pier Giorgio RAPONI, San Jose, CA (US)

(21) Appl. No.: 15/903,502

(22) Filed: Feb. 23, 2018

Related U.S. Application Data
(63) Continuation of application No. 15/854,508, filed on Dec. 26, 2017.
(60) Provisional application No. 62/439,440, filed on Dec. 27, 2016.

(51) Int. Cl. H04L 12/933; H04L 12/851; H04L 12/721; H04L 12/751; H04L 12/713

(52) U.S. Cl. CPC H04L 49/109; H04L 47/2441; H04L 45/38; H04L 45/586; H04L 45/02

(57) ABSTRACT

In example implementations of the present disclosure, there is a processing of a specification and/or other parameters to generate a NoC with traffic flows that meet the specification requirements. In example implementations, the specification is processed to determine the characteristics of the NoC to be generated, the characteristics of the traffic flow (e.g. number of hops, bandwidth requirements, type of flow such as request/response, quality of service, traffic type, etc.), flow mapping decision strategy (e.g., limit on number of new virtual channels to be constructed, using of existing VCs, or generation of new, yx/xy mapping, other routing types, traffic flow isolation by layer or by VC depending of the type of traffic, and/or the presence of single or multi-beat traffic, etc.) to be used for how the flows are to be mapped to the network.

### CROSS REFERENCE TO RELATED APPLICATION

This regular U.S. patent application is a continuation of U.S. patent application Ser. No. 15/854,508, filed on Dec. 26, 2017, which is based on and claims the benefit of priority under 35 U.S.C. 119 from provisional U.S. Patent application No. 62/439,440, filed on Dec. 27, 2016, the entire disclosure of which is incorporated by reference herein.

### BACKGROUND

### Technical Field

Methods and example implementations described herein are directed to interconnect architecture, and more specifically, to reconfiguring Network on Chip (NoC) to customize traffic and optimize performance after NoC is designed and deployed.

### Related Art

The number of components on a chip is rapidly growing due to increasing levels of integration, system complexity and shrinking transistor geometry. Complex System-on-Chips (SoCs) may involve a variety of components e.g., processor cores, DSPs, hardware accelerators, memory and I/O, while Chip Multi-Processors (CMPs) may involve a large number of homogenous processor cores, memory and I/O subsystems. In both SoC and CMP systems, the on-chip interconnect plays a role in providing high-performance communication between the various components. Due to scalability limitations of traditional buses and crossbar based interconnects, Network-on-Chip (NoC) has emerged as a paradigm to interconnect a large number of components on the chip. NoC is a global shared communication infrastructure made up of several routing nodes interconnected with each other using point-to-point physical links.

Messages are injected by the source and are routed from the source node to the destination over multiple intermediate nodes and physical links. The destination node then ejects the message and provides the message to the destination. For the remainder of this application, the terms ‘components’, ‘blocks’, ‘hosts’ or ‘cores’ will be used interchangeably to refer to the various system components which are interconnected using a NoC. Terms ‘routers’ and ‘nodes’ will also be used interchangeably. Without loss of generalization, the system with multiple interconnected components will itself be referred to as a ‘multi-core system’.

There are several topologies in which the routers can connect to one another to create the system network. Bi-directional rings (as shown in FIG. 1(a)), 2-D (two dimensional) mesh (as shown in FIG. 1(b)) and 2-D Torus (as shown in FIG. 1(c)) are examples of topologies in the related art. Mesh and Torus can also be extended to 2.5-D (two and half dimensional) or 3-D (three dimensional) organizations. FIG. 1(d) shows a 3D mesh NoC, where there are three layers of 3×3 2D mesh NoC shown over each other. The NoC routers have up to two additional ports, one connecting to a router in the higher layer, and another connecting to a router in the lower layer. Router 111 in the middle layer of the example has both ports used, one connecting to the router at the top layer and another connecting to the router at the bottom layer. Routers 110 and 112 are at the bottom and top mesh layers respectively, therefore they have only the upper facing port 113 and the lower facing port 114 respectively connected.

Packets are message transport units for intercommunication between various components. Routing involves identifying a path composed of a set of routers and physical links of the network over which packets are sent from a source to a destination. Components are connected to one or multiple ports of one or multiple routers; with each such port having a unique ID. Packets carry the destination's router and port ID for use by the intermediate routers to route the packet to the destination component.

Examples of routing techniques include deterministic routing, which involves choosing the same path from A to B for every packet. This form of routing is independent from the state of the network and does not load balance across path diversities, which might exist in the underlying network. However, such deterministic routing may implemented in hardware, maintains packet ordering and may be rendered free of network level deadlocks. Shortest path routing may minimize the latency as such routing reduces the number of hops from the source to the destination. For this reason, the shortest path may also be the lowest power path for communication between the two components. Dimension-order routing is a form of deterministic shortest path routing in 2-D, 2.5-D, and 3-D mesh networks. In this routing scheme, messages are routed along each coordinates in a particular sequence until the message reaches the final destination. For example in a 3-D mesh network, one may first route along the X dimension until it reaches a router whose X-coordinate is equal to the X-coordinate of the destination router. Next, the message takes a turn and is routed in along Y dimension and finally takes another turn and moves along the Z dimension until the message reaches the final destination router. Dimension ordered routing may be minimal turn and shortest path routing.

FIG. 2(a) pictorially illustrates an example of XY routing in a two dimensional mesh. More specifically, FIG. 2(a) illustrates XY routing from node ‘34’ to node ‘00’. In the example of FIG. 2(a), each component is connected to only one port of one router. A packet is first routed over the x-axis till the packet reaches node ‘04’ where the x-coordinate of the node is the same as the x-coordinate of the destination node. The packet is next routed over the y-axis until the packet reaches the destination node.

In heterogeneous mesh topology in which one or more routers or one or more links are absent, dimension order routing may not be feasible between certain source and destination nodes, and alternative paths may have to be taken. The alternative paths may not be shortest or minimum turn.

Source routing and routing using tables are other routing options used in NoC. Adaptive routing can dynamically change the path taken between two points on the network based on the state of the network. This form of routing may be complex to analyze and implement.

A NoC interconnect may contain multiple physical networks. Over each physical network, there may exist multiple virtual networks, wherein different message types are transmitted over different virtual networks. In this case, at each physical link or channel, there are multiple virtual channels; each virtual channel may have dedicated buffers at both end points. In any given clock cycle, only one virtual channel can transmit data on the physical channel.

NoC interconnects may employ wormhole routing, wherein, a large message or packet is broken into small pieces known as flits (also referred to as flow control digits). The first flit is the header flit, which holds information about this packet's route and key message level info along with payload data and sets up the routing behavior for all subsequent flits associated with the message. Optionally, one or more body flits follows the head flit, containing the remaining payload of data. The final flit is the tail flit, which in addition to containing the last payload also performs some bookkeeping to close the connection for the message. In wormhole flow control, virtual channels are often implemented.

The physical channels are time sliced into a number of independent logical channels called virtual channels (VCs). VCs provide multiple independent paths to route packets, however they are time-multiplexed on the physical channels. A virtual channel holds the state needed to coordinate the handling of the flits of a packet over a channel. At a minimum, this state identifies the output channel of the current node for the next hop of the route and the state of the virtual channel (idle, waiting for resources, or active). The virtual channel may also include pointers to the flits of the packet that are buffered on the current node and the number of flit buffers available on the next node.

The term “wormhole” plays on the way messages are transmitted over the channels: the output port at the next router can be so short that received data can be translated in the head flit before the full message arrives. This allows the router to quickly set up the route upon arrival of the head flit and then opt out from the rest of the conversation. Since a message is transmitted flit by flit, the message may occupy several flit buffers along its path at different routers, creating a worm-like image.

Based upon the traffic between various end points, and the routes and physical networks that are used for various messages, different physical channels of the NoC interconnect may experience different levels of load and congestion. The capacity of various physical channels of a NoC interconnect is determined by the width of the channel (number of physical wires) and the clock frequency at which it is operating. Various channels of the NoC may operate at different clock frequencies, and various channels may have different widths based on the bandwidth requirement at the channel. The bandwidth requirement at a channel is determined by the flows that traverse over the channel and their bandwidth values. Flows traversing over various NoC channels are affected by the routes taken by various flows. In a mesh or Taurus NoC, there may exist multiple route paths of equal length or number of hops between any pair of source and destination nodes. For example, in FIG. 2(b), in addition to the standard XY route between nodes 34 and 00, there are additional routes available, such as YX route 203 or a multi-turn route 202 that makes more than one turn from source to destination.

In a NoC with statically allocated routes for various traffic slows, the load at various channels may be controlled by intelligently selecting the routes for various flows. When a large number of traffic flows and substantial path diversity is present, routes can be chosen such that the load on all NoC channels is balanced nearly uniformly, thus avoiding a single point of bottleneck. Once routed, the NoC channel widths can be determined based on the bandwidth demands of flows on the channels. Unfortunately, channel widths cannot be arbitrarily large due to physical hardware design restrictions, such as timing or wiring congestion. There may be a limit on the maximum channel width, thereby putting a limit on the maximum bandwidth of any single NoC channel.

Additionally, wider physical channels may not help in achieving higher bandwidth if messages are short. For example, if a packet is a single flit packet with a 64-bit width, then no matter how wide a channel is, the channel will only be able to carry 64 bits per cycle of data if all packets over the channel are similar. Thus, a channel width is also limited by the message size in the NoC. Due to these limitations on the maximum NoC channel width, a channel may not have enough bandwidth in spite of balancing the routes.

To address the above bandwidth concern, multiple parallel physical NoCs may be used. Each NoC may be called a layer, thus creating a multi-layer NoC architecture. Hosts inject a message on a NoC layer; the message is then routed to the destination on the NoC layer, where it is delivered from the NoC layer to the host. Thus, each layer operates more or less independently from each other, and interactions between layers may only occur during the injection and ejection times. FIG. 3(a) illustrates a two layer NoC. Here the two NoC layers are shown adjacent to each other on the left and right, with the hosts connected to the NoC replicated in both left and right diagrams. A host is connected to two routers in this example—a router in the first layer shown as R1, and a router is the second layer shown as R2. In this example, the multi-layer NoC is different from the 3D NoC, i.e. multiple layers are on a single silicon die and are used to meet the high bandwidth demands of the communication between hosts on the same silicon die. Messages do not go from one layer to another. For purposes of clarity, the present application will utilize such a horizontal left and right illustration for multi-layer NoC to differentiate from the 3D NoCs, which are illustrated by drawing the NoCs vertically over each other.

In FIG. 3(b), a host connected to a router from each layer, R1 and R2 respectively, is illustrated. Each router is connected to other routers in its layer using directional ports 301, and is connected to the host using injection and ejection ports 302. A bridge-logic 303, or bridge, may sit between the host and the two NoC layers to determine the NoC layer for an outgoing message and sends the message from host to the NoC layer, and also perform the arbitration and multiplexing between incoming messages from the two NoC layers and delivers them to the host.

In a multi-layer NoC, the number of layers needed may depend upon a number of factors such as the aggregate bandwidth requirement of all traffic flows in the system, the routes that are used by various flows, message size distribution, maximum channel width, etc. Once the number of NoC layers in NoC interconnect is determined in a design, different messages and traffic flows may be routed over different NoC layers. Additionally, one may design NoC interconnects such that different layers have different topologies in number of routers, channels and connectivity. The channels in different layers may have different widths based on the flows that traverse over the channel and their bandwidth requirements.

In a NoC interconnect, if the traffic profile is not uniform and there is a certain amount of heterogeneity (e.g., certain hosts talking to each other more frequently than the others), the interconnect performance may depend on the NoC topology and where various hosts are placed in the topology with respect to each other and to what routers they are connected to. For example, if two hosts talk to each other frequently and require higher bandwidth than other interconnects, then they should be placed next to each other. This will reduce the latency for this communication which thereby reduces the global average latency, as well as reduce the number of router nodes and links over which the higher bandwidth of this communication must be provisioned.

Moving two hosts closer together may make certain other hosts far apart since all hosts must fit into the 2D planar NoC topology without overlapping with each other. Thus, various tradeoffs must be made and the hosts must be placed after examining the pair-wise bandwidth and latency requirements between all hosts so that certain global cost and performance metrics is optimized. The cost and performance metrics can be, for example, average structural latency between all communicating hosts in number of router hops, or sum of bandwidth between all pair of hosts and the distance between them in number of hops, or some combination of these two. This optimization problem is known to be NP-hard and heuristic based approaches are often used. The hosts in a system may vary in shape and sizes with respect to each other, which puts additional complexity in placing them in a 2D planar NoC topology, packing them optimally while leaving little whitespaces, and avoiding overlapping hosts.

The optimization approaches introduced so far to determine the channel capacity, routes, host positions, etc., are useful when the exact traffic profile is known in advance at the NoC design time. If the precise traffic profile is not known at the design time, and the traffic profile changes during the NoC operation based on the SoC application's requirements, then the NoC design must allow these adjustments. For the NoC to allow these changes, the NoC must be designed so that it has knowledge of the changes that may occur in the traffic profile in a given system and ensure that any combination of allowable traffic profiles are supported by the NoC hardware architecture.

### SUMMARY

Aspects of the present disclosure include generating a NoC from a NoC specification, the NoC specification is given by the external constraints such as agents, bridges and their physical position, traffic, power, clock domains, on die blockages, and so on depending on the desired implementation. The strategy for NoC generation is to utilize the design exploration space that is available, and includes all possible combinations of rules to map a flow on the NoC. Such rules can include certain flow routing constraint (xy, yx, xyx, yxy, none, or other), separation between single beat and multi beat traffic on different routes, separation of request traffic from response traffic on different routes or layers, the minimization of a certain cost function to reduce the total number of wires, or the overall maximum link width, the ability to use different virtual channels (VC) for the same traffic flow, isolation of traffic flows that are congested, use of interface traffic rate limitation based on the capability of receiving traffic of the destination interface, isolation of interfaces, and so on depending on the desired implementation.

Example implementations are directed to utilize the design exploration space of a NoC. The design exploration space is the entire space of rules or strategies available that have to be followed in order to map a traffic flow in the NoC. The design exploration space includes all the strategies that are available to generate the NoC according to the specification. Within the design exploration space are a list of possible NoC generation techniques or constraints that are honored by the traffic flows that are mapped in the NoC, wherein a point within the design exploration space involves a combination of choices for each available strategy, such as route xy, separation between single and multibeat ON, separation for request/response traffic being OFF, VC remapping set to ON, traffic isolation DONTCARE, and so on depending on the desired NoC according to the NoC specification.

Together with the strategy there is a first sorting function that orders the traffic flows. In example implementations the sorting function is utilized as a technique to uniquely order a pool of items (traffic flows in example implementations) to meet more or one criteria for the NoC. The first sorting function can be any sorting function in accordance with the desired implementation (e.g., shortest number of hops, lowest latency, highest bandwidth requirement, number of VCs used, etc.)

Flows are then picked up in the first order, for each flow, the machine learning algorithm selects an optimal strategy among the entire space, based on the current state of the NoC. In the first iteration, the state of the NoC involves the locations of the routers, bridges and channels, and no traffic flows as described in FIG. 4 incorporated into the NoC. Then the flow is mapped in the NoC using the selected optimal strategy. After mapping, the state of the NoC is updated to reflect the added flow before processing the next traffic flow. The iteration ends when all the flows are eventually mapped. The optimal strategy selected will be in the form of a combination of the elements in the design exploration space (e.g., any combination of route xy, separation between single and multi beat ON, separation request/response traffic OFF, VC remapping ON, traffic isolation DONTCARE, and so on).

The machine learning predictor can belong the class of supervised learning, or can be an unsupervised learning algorithm.

In an extended implementation the machine learning algorithm can decide to postpone the mapping of the current flow, and map based on a second sorting function.

In an extended implementation, the first sorting function is not provided, and a second machine learning algorithm determines the flow order based on the combination of external constraints and NoC state.

In example implementations, the machine learning based algorithms can provide a determination of the flow mapping decision strategy as to if a strategy applied to the flow is acceptable or not in view of the specification and flow characteristics (e.g., via a quality score which predicts the likelihood of that flows to meet the specified requirements using this mapping strategy). In example implementations, the decisions based on the machine learning algorithms can be applied on a flow by flow basis, and can involve supervised learning or unsupervised learning algorithms.

Aspects of the present disclosure can involve a method for generating a Network on Chip (NoC) from a NoC specification, which can involve utilizing external constraints given by a specification and a design exploration space to map one or more traffic flows on the NoC according to a NoC generation strategy selected among the design exploration space to enforce all possible combinations of the constraints, the design exploration space involving at least one of routing constraints for the NoC, design exploration space involving a separation between different types of traffic of the NoC, minimization of a cost function, utilization of different virtual channels (VC) for the same traffic flow, isolation of traffic flows that are congested, and utilization of interface traffic rate limitation based on the capability of receiving traffic of the destination interface, wherein the design exploration space determined from external constraints is derived from the NoC specification.

Aspects of the present disclosure can involve a non-transitory computer readable medium storing instructions for generating a Network on Chip (NoC) from a NoC specification, which can involve utilizing external constraints given by a specification and a design exploration space to map one or more traffic flows on the NoC according to a NoC generation strategy selected among the design exploration space to enforce all possible combinations of the constraints, the design exploration space involving at least one of routing constraints for the NoC, design exploration space involving a separation between different types of traffic of the NoC, minimization of a cost function, utilization of different virtual channels (VC) for the same traffic flow, isolation of traffic flows that are congested, and utilization of interface traffic rate limitation based on the capability of receiving traffic of the destination interface, wherein the design exploration space determined from external constraints is derived from the NoC specification.

Aspects from the present disclosure further include an apparatus configured to generate a Network on Chip (NoC) from a NoC specification, which can involve a processor, configured to: utilize external constraints given by a specification and a design exploration space to map one or more traffic flows on the NoC according to a NoC generation strategy selected among the design exploration space to enforce all possible combinations of the constraints, the design exploration space involving at least one of route constraints for the NoC, design exploration space involving a separation between different types of traffic of the NoC, minimization of a cost function, utilization of different virtual channels (VC) for the same traffic flow, isolation of traffic flows that are congested, and utilization of interface traffic rate limitation based on the capability of receiving traffic of the destination interface, wherein the design exploration space determined from external constraints is derived from the NoC specification.

### BRIEF DESCRIPTION OF THE DRAWINGS

FIGS. 1(a), 1(b) 1(c) and 1(d) illustrate examples of Bidirectional ring, 2D Mesh, 2D Taurus, and 3D Mesh NoC Topologies.

FIG. 2(a) illustrates an example of XY routing in a related art two dimensional mesh.

FIG. 2(b) illustrates three different routes between a source and destination nodes.

FIG. 3(a) illustrates an example of a related art two layer NoC interconnect.

FIG. 3(b) illustrates the related art bridge logic between host and multiple NoC layers.

FIG. 4 illustrates an example NoC mapping, in accordance with an example implementation.

FIGS. 5(a) to 5(c) illustrate example flow diagrams in accordance with an example implementation.

FIG. 6 illustrates a computer/server block diagram upon which the example implementations described herein may be implemented.

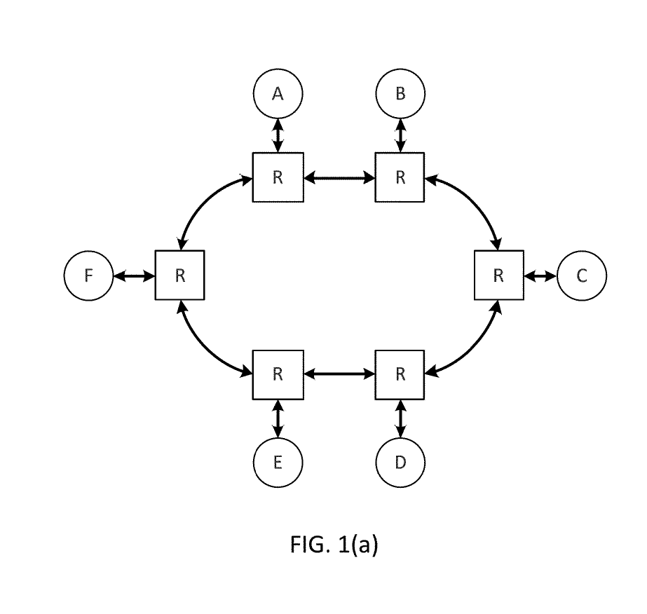

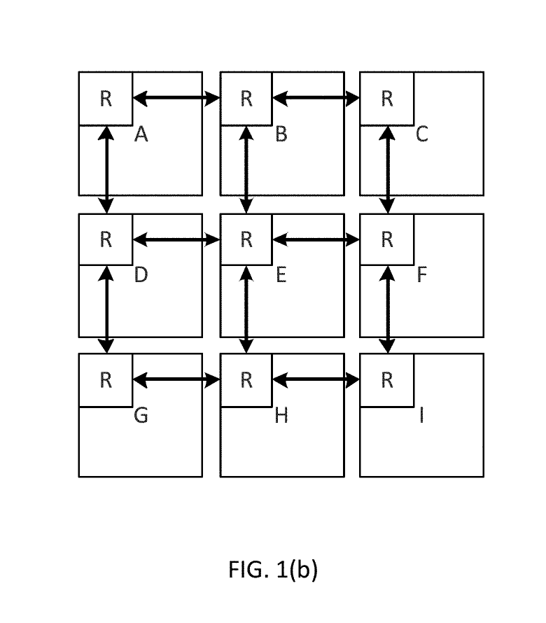

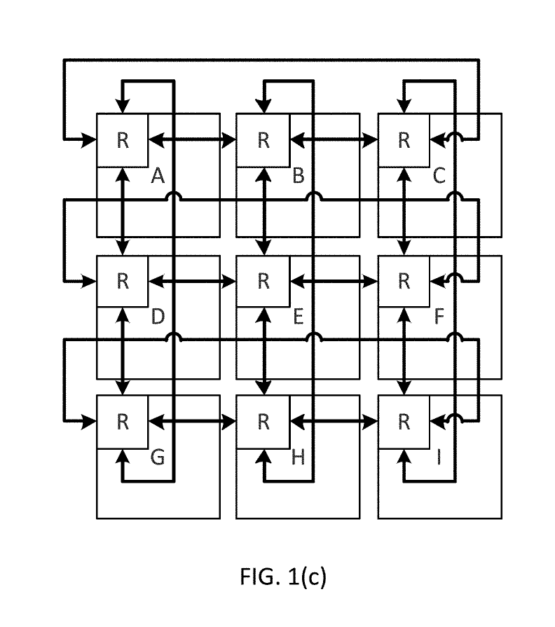

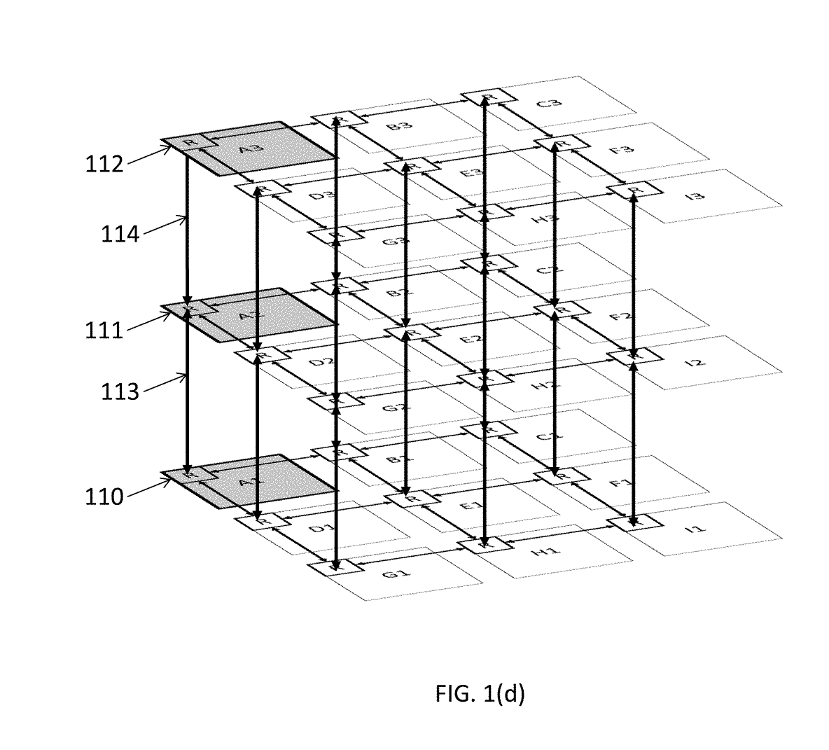

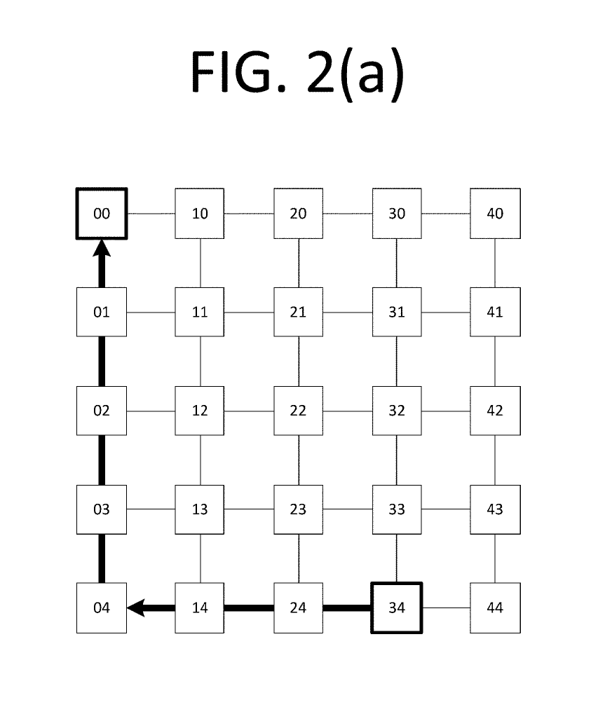

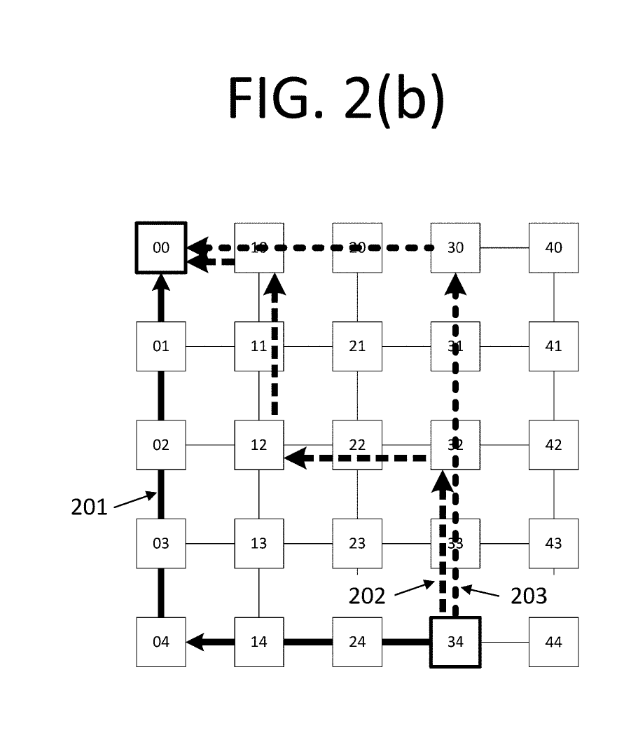

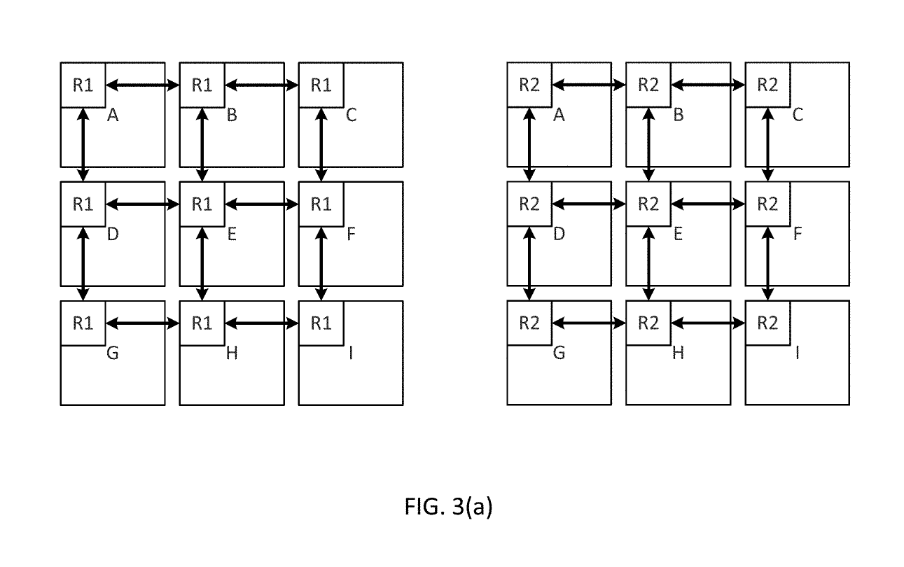

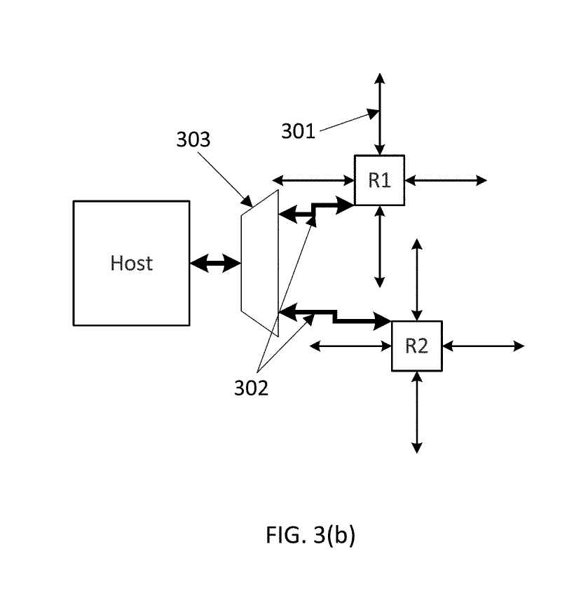

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application.

In example implementations, a NoC interconnect is generated from a specification by utilizing design tools. The specification can contain constraints such as bandwidth/Quality of Service (QoS)/latency attributes that is to be met by the NoC, and can be in various software formats depending on the design tools utilized. Once the NoC is generated through the use of design tools on the specification to meet the specification requirements, the physical architecture can be implemented either by manufacturing a chip layout to facilitate the NoC or by generation of a register transfer level (RTL) for execution on a chip to emulate the generated NoC, depending on the desired implementation. Specifications may be in common power format (CPF), Unified Power Format (UPF), or others according to the desired specification. Specifications can be in the form of traffic specifications indicating the traffic, bandwidth requirements, latency requirements, interconnections and so on depending on the desired implementation. Specifications can also be in the form of power specifications to define power domains, voltage domains, clock domains, and so on, depending on the desired implementation.

A distributed NoC interconnect connects various components in a system on chip with each other using multiple routers and point to point links between the routers. The traffic profile of a SoC includes the transactions between various components in the SoC and their properties (e.g., Quality of Service (QoS), priority, bandwidth and latency requirements, transaction sizes, etc.). The traffic profile information may be used to determine how various transactions will be routed in the NoC topology, and accordingly provision the link capacities, virtual channels and router nodes of the NoC. Accurate knowledge of the traffic profile can lead to an optimized NoC hardware with minimal overprovisioning in terms of link wires, virtual channel buffers and additional router nodes. A variety of SoCs today are designed to run a number of different applications; the resulting NoC traffic profile therefore may differ based on how and in what market segments the SoC is deployed, and what applications are supported. Supporting a variety of traffic profiles offers several challenges in the NoC design and optimization. Even if multiple traffic profiles are supported functionally, the traffic profile observed in a particular setting may be different from the set of profiles for which the NoC is optimized, leading to sub-optimal power consumption and NoC performance.

Example implementations described herein are directed to solutions for 2-D, 2.5-D and 3-D NoC interconnects. The example implementations may involve various aspects, such as: 1) designing a NoC to one or more traffic profiles of a traffic specification by mapping their transactions to NoC and allocating routes, virtual channels, and layers; 2) supporting hardware reconfigurability in the NoC to be able to optimize the NoC performance for a given subset of traffic profiles present in a SoC; 3) using example implementations herein to process each flow to optimize the mapping of the flows to the NoC hardware; 4) based on the determined flows, generating the reconfiguration information to be loaded into the NoC hardware; and 5) finally transmitting the reconfiguration information to the NoC in a format that can be loaded into NoC reconfiguration hardware.

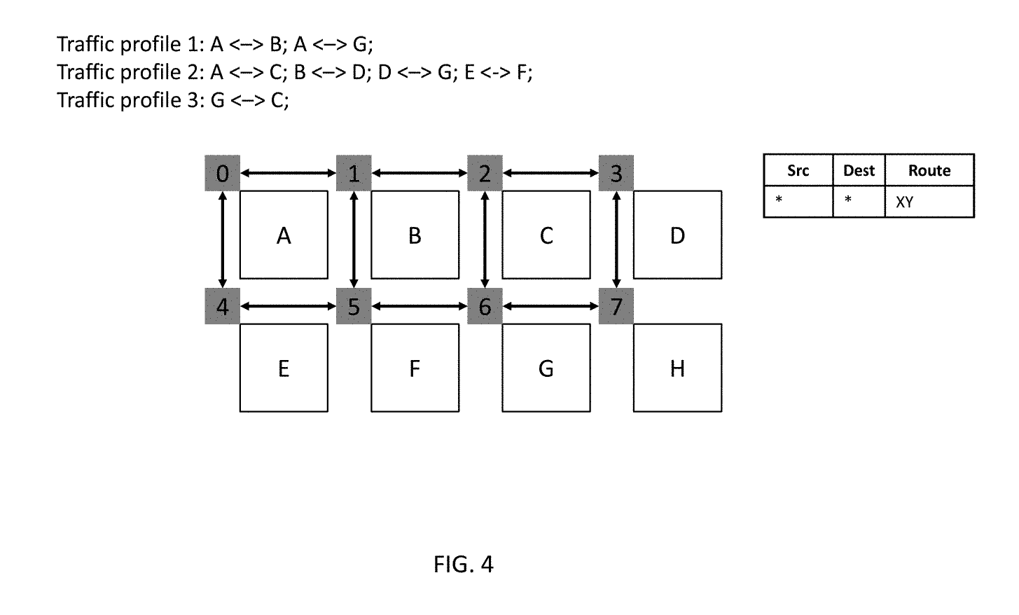

FIG. 4 illustrates an example of a traffic specification including multiple traffic profiles mapped to the NoC interconnect and mapping the transactions. Here there are three traffic profiles that need to be supported in a NoC interconnect connecting eight hosts, A, B, C, D, E, F, G, H. The inter-component communications of the three traffic profiles are as follows:

Traffic Profile 1: A <—>B; A <—>G;

Traffic Profile 2: A <—>C; B <—>D; D <—>G; E <—>F;

Traffic Profile 3: G <—>C;

The example NoC of FIG. 4 is a 4×2 mesh topology. To support the three traffic profiles, routes and virtual channels are allocated for each transaction of all of the traffic profiles. In this case, a single NoC layer is allocated (for additional bandwidth and channels, more NoC layers may be allocated). A number of schemes can be used for allocation of NoC channels and routes and multiple layers, some of which are described in U.S. application Ser. Nos. 13/599,559, 13/745,684, and 13/752,226, hereby incorporated by reference for all purposes in their entirety. In this example, XY routes are used for all transactions, and the links and router nodes along the routes of all transactions in the three traffic profiles are allocated as shown in FIG. 4. Virtual channels allocated at various links between routers are omitted for clarity.

Example implementations are directed to the utilization of machine learning based algorithms. In the related art, a wide range of machine learning based algorithms have been applied to image or pattern recognition, such as the recognition of obstacles or traffic signs of other cars, or the categorization of elements based on a specific training. In view of the advancement in power computations, machine learning has become more applicable for the generation of NoCs and for the mapping of traffic flows of NoCs.

In example implementations, the NoC is designed with agents, bridges, and the traffic specification, wherein a mapping algorithm attempts to map the traffic flows and determine if the flows should be included in the NoC generation process or not. Flows are processed in an incremental way. In example implementations, the specification is also processed to determine the characteristics of the NoC to be generated, the characteristics of the flow (e.g. number of hops, bandwidth requirements, type of flow such as request/response, etc.), flow mapping decision strategy (e.g., limit on number of new virtual channels to be constructed, using of existing VCs, yx/xy mapping, other routing types), and desired strategy to be used for how the flows are to be mapped to the network.

In example implementations of the present disclosure, there is a processing of a specification and/or other parameters to generate a NoC with flows that meet the specification requirements. In example implementations, the specification is processed to determine the characteristics of the NoC to be generated, the characteristics of the flow (e.g. number of hops, bandwidth requirements, type of flow such as request/response, etc.), flow mapping decision strategy (e.g., limit on number of new virtual channels to be constructed, using of existing VCs, exploration of different routing algorithms), and desired strategy to be used for how the flows are to be mapped to the network. In such processing, the machine learning based algorithm can provide a determination as to if a flow is acceptable or not in view of the specification (e.g., via a quality score). In example implementations, the machine learning decisions can be applied on a flow by flow basis, and can involve supervised learning or unsupervised learning algorithms.

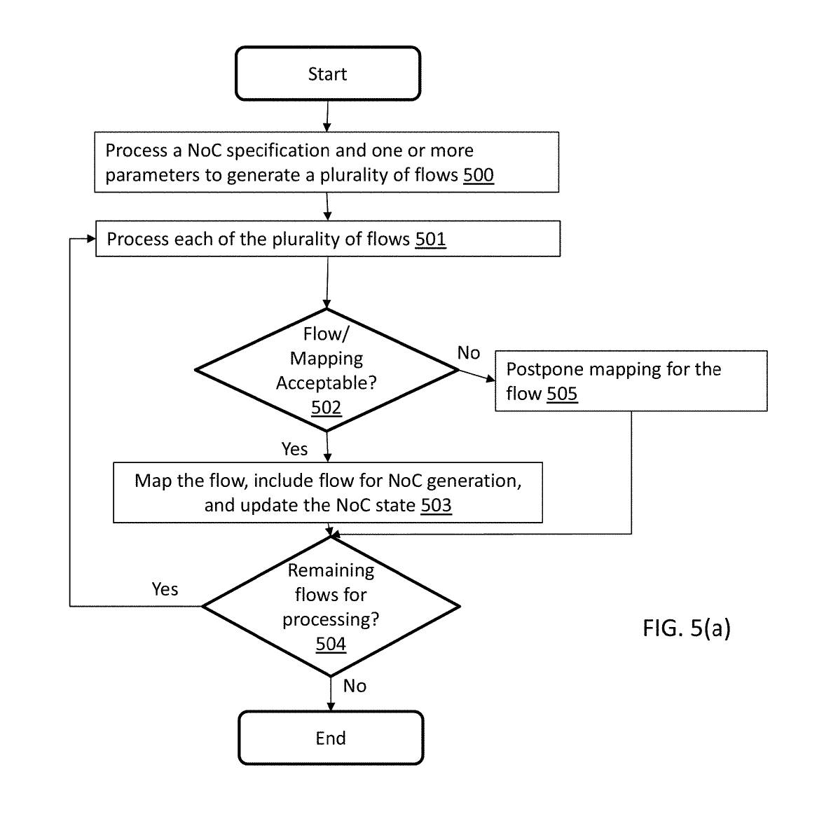

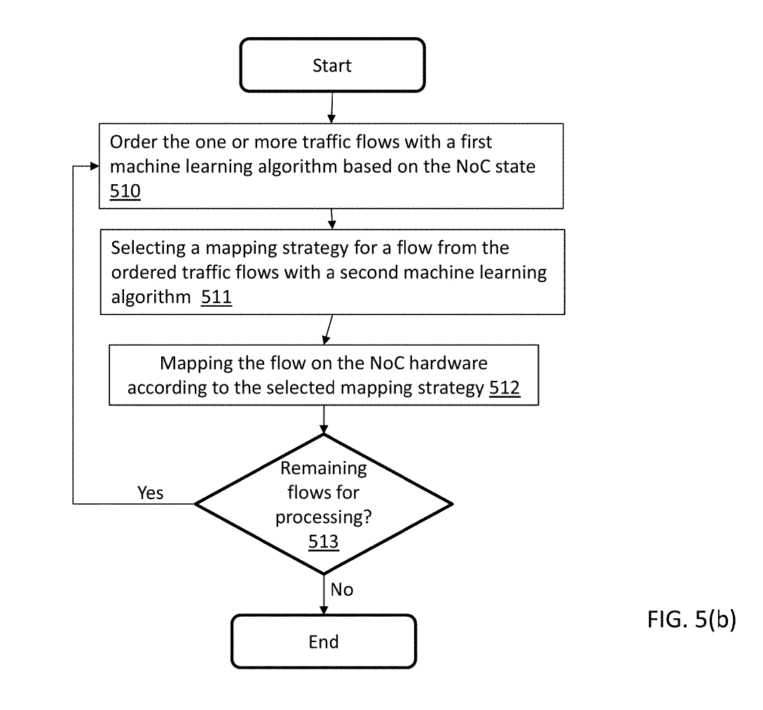

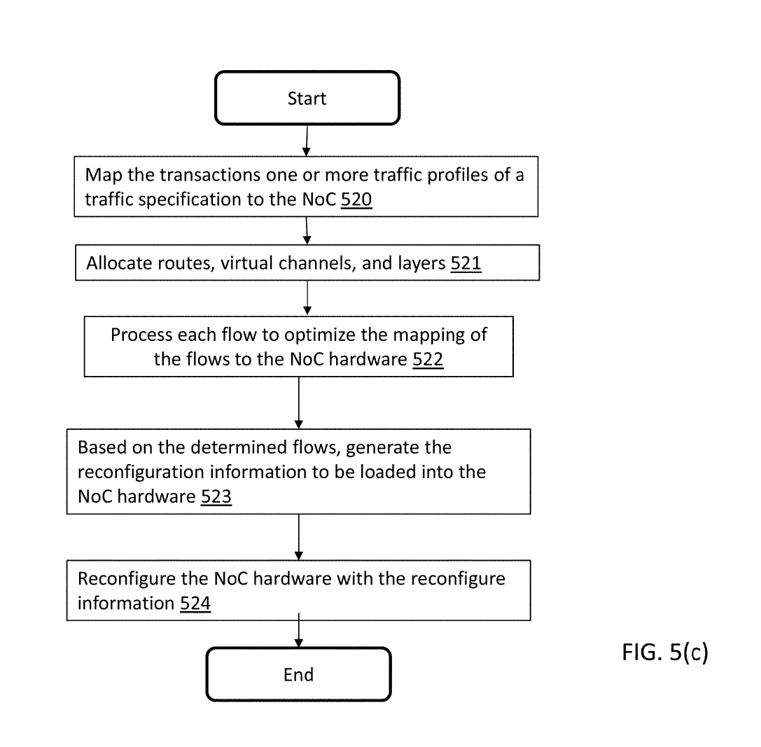

FIG. 5(a) illustrates an example flow diagram, in accordance with an example implementation. In the example implementation of FIG. 5(a), unsupervised machine learning algorithms can be applied to determine flows. At 500, the NoC specification (e.g. traffic specification, power specification, etc.) and/or one or more additional parameters (e.g., NoC topology, desired flow strategy, etc.) to generate the plurality of flows. In example implementations, the flow strategy can include the desired type of mapping (e.g., xy routing, yx routing, minimize or maximize use of the same VCs, minimize or maximize use of the same routes, maximize or minimize the number of layer, minimize the total cost, etc.).

At 501, each of the plurality of flows is processed. The processing is conducted based on supervised or unsupervised machine learning based algorithms to score each individual flow. The machine learning algorithm can be trained to (in case of supervised learning) or might aim at (in case of unsupervised learning) maximizing the desired characteristics of NoC, desired characteristics of traffic, or the desired traffic order based on the strategy, given as an input the traffic specification and the desired strategy.

At 502, a determination is made as to whether the traffic flow is acceptable or not for the NoC, and/or whether the mapping according to the desired strategy is acceptable or not for the NoC. If so (Yes), then the flow diagram proceeds to 503 to include the flow for NoC generation. Otherwise (No), the flow diagram proceeds to 505 to skip or postpone mapping for the flow. In an example implementation, the traffic flow can be placed back into the set of traffic flows to be mapped, and the machine learning algorithm can proceed to select a new candidate to be mapped. At 504, a determination is made as to if there are remaining flows for processing. If so (Yes), then the flow diagram proceeds back to 501, otherwise (No), the flow diagram ends.

The output of the flow of FIG. 5(a) can include a list of flows and the mapping to the NoC as illustrated in FIG. 4, which can be indicative of if the strategy applied to the NoC is sufficient or insufficient. From the output, a NoC can be generated in accordance with the provided flow mapping.

In another example implementation, machine learning algorithms based on unsupervised learning can also provide an output, strategy and best way to merge traffic or produce traffic, from which NoC generation can be conducted. For example, if the aggregate scoring of the flows based on the strategy fails to meet a desired threshold, the strategy can be determined as not being appropriate for a particular NoC structure. Such feedback can be provided into the unsupervised machine learning algorithms on a flow-by-flow basis.

In such example implementations, alternate strategies can also be suggested, depending on the desired implementation. So, given a trained machine learning algorithm, the input parameters at 500 can include the characteristics of the NoC, characteristics of the traffic flow, and the desired flow mapping decision strategies. Depending on the desired implementation, the output can include one or more of the generated NoC or a list of possible generated NoCs that meet a threshold, and a true/false indication as to whether the strategy should be applied for the NoC generation.

In example implementations, the characteristics of the flow can also be derived by the unsupervised machine learning processes, and can involve a set of characteristics to match the traffic flows. Examples of characteristics that can be derived by unsupervised machine learning can include for example how many channels, what is the rate of the flow, what is the bandwidth of the flow, the isolation of certain types of flows from others, or so on depending on the desired implementation, to describe the required characteristics for a particular flow that is being mapped.

Further, example implementations may determine a strategy regarding how the flow is to be mapped to the network. Such strategies that can be applied include XY routing, YX routing, other types of multi-turn routing strategies that might not necessarily follow the shortest path, create new VC when needed, use existing VC if possible and so on to determine how the flow is going to be mapped on the network. Example implementations can determine, based on the scoring of the flows, if the strategy applied will lead to an outcome that meets a threshold or not for the desired characteristics.

FIG. 5(b) illustrates an example flow diagram, in accordance with an example implementation. In this example implementation, the flow of FIG. 5(b) can replace the flow of FIG. 5(a) from the process at 511 and onwards. In another example implementation, the utilizing the constraints of the NoC specification and the design exploration space associated with the NoC specification to map one or more traffic flows on the NoC according to the NoC generation strategy involves ordering the one or more traffic flows through utilization of a first machine learning algorithm based on the external constraints and a current state of the NoC as shown at 510. At 511, for a first one of the one or more ordered traffic flows, the flow diagram selects an optimal strategy among the entire design exploration space through utilizing a second machine learning algorithm, based on the current state of the NoC as flows are mapped. At 512, the process maps the corresponding flow from the one or more ordered traffic flows to the NoC by using the selected strategy. Based on the added flow, the state of the NoC can thereby be updated. At 513, if there are remaining flows left for processing (Yes), then the process returns back to 510 so that the remaining one or more ordered traffic flows can be reordered by the first machine learning algorithm based on the updated state of the NoC. When all of the flows are processed (No), then the flow diagram of FIG. 5(b) ends.

FIG. 5(c) illustrates an example flow diagram, in accordance with an example implementation. At 520, example implementations may design a NoC to one or more traffic profiles of a traffic specification by mapping their traffic transactions to NoC and allocating routes, virtual channels, and layers. Example implementations may also support hardware reconfigurability in the NoC to be able to optimize the NoC performance for a given subset of traffic profiles present in a SoC. At 521, routes, virtual channels, and layers are allocated to the NoC. At 522, the flow at FIG. 5(a) or FIG. 5(b) is executed to process each flow to optimize the mapping of the flows to the NoC hardware. At 523, based on the determined flows, example implementations may generate the reconfiguration information to be loaded into the NoC hardware; and at 524, example implementations finally transmit the reconfiguration information to the NoC in a format that can be loaded into NoC reconfiguration hardware.

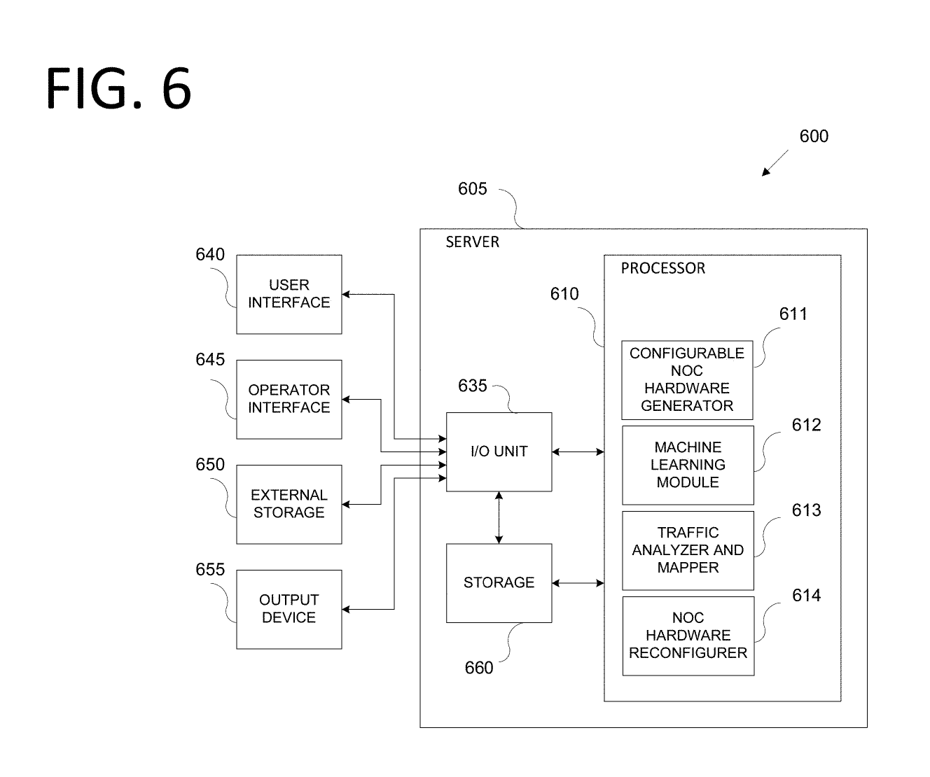

FIG. 6 illustrates an example computer system 600 on which example implementations may be implemented. The computer system 600 includes a server 605 which may involve an I/O unit 635, storage 660, and a processor 610 operable to execute one or more units as known to one of skill in the art. The term “computer-readable medium” as used herein refers to any medium that participates in providing instructions to processor 610 for execution, which may come in the form of computer-readable storage mediums, such as, but not limited to optical disks, magnetic disks, read-only memories, random access memories, solid state devices and drives, or any other types of tangible media suitable for storing electronic information, or computer-readable signal mediums, which can include transitory media such as carrier waves. The I/O unit processes input from user interfaces 640 and operator interfaces 645 which may utilize input devices such as a keyboard, mouse, touch device, or verbal command.

The server 605 may also be connected to an external storage 650, which can contain removable storage such as a portable hard drive, optical media (CD or DVD), disk media or any other medium from which a computer can read executable code. The server may also be connected an output device 655, such as a display to output data and other information to a user, as well as request additional information from a user. The connections from the server 605 to the user interface 640, the operator interface 645, the external storage 650, and the output device 655 may via wireless protocols, such as the 802.11 standards, Bluetooth® or cellular protocols, or via physical transmission media, such as cables or fiber optics. The output device 655 may therefore further act as an input device for interacting with a user.

The processor 610 may execute one or more modules. The configurable NoC hardware generator module 611 may be configured to intake the NoC specification and the traffic flows generated by the Machine Learning Module 612. The machine learning module 612 may execute flows as described in FIGS. 5(a) and 5(b) to select a strategy for mapping flows based on the NoC specification and map the flows. The traffic analyzer and mapper module 613 can be used for analyzing traffic flows and mapping them to the NoC hardware. NoC hardware reconfigurer module 614 may be configured to collect the mapped traffic flows provided by the machine learning module 612, reformat this data into a format than can be loaded into the configurable NoC hardware, and transmit the data to configure the NoC hardware elements to perform the configuration.

In example implementations, the processor 610 can be configured to execute the flow diagrams as illustrated from FIGS. 5(a) to 5(c) to generate a NoC from a NoC specification through the use of the modules as described above. Processor 610 can be configured to utilizing external constraints given by a specification and a design exploration space (e.g., maximum area allowed for the NoC, latency requirements, bandwidth requirements, number of agents to be supported, etc.), to map one or more traffic flows on the NoC according to a NoC generation strategy selected among the design exploration space to enforce all possible combinations of the constraints. Such a design exploration space can include routing constraints for the NoC, design exploration space involving a separation between different types of traffic of the NoC, minimization of a cost function, utilization of different virtual channels (VC) for the same traffic flow, isolation of traffic flows that are congested, and utilization of interface traffic rate limitation based on the capability of receiving traffic of the destination interface. The design exploration space can be determined from external constraints, which is derived from the NoC specification according to any desired implementation.

Processor 610 is configured to utilize the external constraints given by a specification and a design exploration space to map one or more traffic flows on the NoC according to a NoC generation strategy selected among the design exploration space to enforce all possible combinations of the constraints by ordering the one or more traffic flows through utilization of a first sorting function, according to any desired sorting function.

In an example implementation of FIG. 5(a), processor 610 can be configured to a) for a first one of the one or more ordered traffic flows, select an optimal strategy among the entire design exploration space through a machine learning algorithm, based on a current state of the NoC; b) map the each of the one or more ordered traffic flows in the NoC using the selected strategy; c) update the state of the NoC based on the added first flow; and d) repeat steps a) to c) for each subsequent flow of the one or more ordered flows until all of the one or more ordered flows are mapped. In such an implementation, each mapped flow corresponds to a selected optimal strategy that is specific to the mapped flow based on the state of the NoC.

Depending on the desired implementation the machine learning algorithm can be one of a trained supervised learning (e.g., trained by using a dataset involving previously generated NoCs considered to be acceptable for a given design exploration space and implemented using neural networks), and unsupervised learning algorithm (e.g., deep learning methods).

In example implementations, the processor 610 can also determine to postpone the mapping of the flow. In such a situation, the remaining flows can be reordered through using a second sorting function (e.g., latency, bandwidth, number of hops, number of VCs utilized, etc.), wherein the mapping can be conducted based on the one or more ordered flows reordered through the second sorting function.

In an example execution of FIG. 5(b), the processor 610 can be configured to utilize external constraints given by a specification and a design exploration space to map one or more traffic flows on the NoC according to a NoC generation strategy selected among the design exploration space to enforce all possible combinations of the constraints comprises ordering the one or more traffic flows through utilization of a first machine learning algorithm based on the external constraints and a current state of the NoC. Processor 610 can be configured to execute the flow of FIG. 5(b) to execute, a) for a first one of the one or more ordered traffic flows, select an optimal strategy among the entire design exploration space through a second machine learning algorithm, based on the current state of the NoC; b) map the each of the one or more ordered traffic flows in the NoC using the selected strategy; c) update the state of the NoC based on the added first flow; d) reorder remaining ones of the one or more ordered traffic flows based on the updated state of the NoC and the first machine learning algorithm; and e) repeat steps a) to d) for each subsequent flow of the one or more ordered flows until all of the one or more ordered flows are mapped. Through this example implementation, the flows are reordered each time a flow is mapped which can be reordered based on the updated state of the NoC.

Furthermore, some portions of the detailed description are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the example implementations, the steps carried out require physical manipulations of tangible quantities for achieving a tangible result.

Moreover, other implementations of the present application will be apparent to those skilled in the art from consideration of the specification and practice of the example implementations disclosed herein. Various aspects and/or components of the described example implementations may be used singly or in any combination. It is intended that the specification and examples be considered as examples, with a true scope and spirit of the application being indicated by the following claims.

What is claimed is:

1. A Network on Chip (NoC) generated from a NoC specification through a process comprising:
utilizing external constraints given by a specification and a design exploration space to map one or more traffic flows on the NoC according to a NoC generation strategy selected among the design exploration space to enforce all possible combinations of the constraints, the design exploration space comprising at least one of:
routing constraints for the NoC, design exploration space involving a separation between different types of traffic of the NoC, minimization of a cost function, utilization of different virtual channels (VC) for the same traffic flow, isolation of traffic flows that are congested, and utilization of interface traffic rate limitation based on the capability of receiving traffic of the destination interface,
wherein the design exploration space determined from external constraints is derived from the NoC specification.

2. The NoC of claim 1, wherein the utilizing external constraints given by a specification and a design exploration space to map one or more traffic flows on the NoC according to a NoC generation strategy selected among the design exploration space to enforce all possible combinations of the constraints comprises ordering the one or more traffic flows through utilization of a first sorting function.

3. The NoC of claim 2, wherein the process further comprises:
a) for a first one of the one or more ordered traffic flows, selecting an optimal strategy among the entire design exploration space through a machine learning algorithm, based on a current state of the NoC;
b) mapping the each of the one or more ordered traffic flows in the NoC using the selected strategy;
c) updating the state of the NoC based on the added first flow;
d) repeat steps a) to c) for each subsequent flow of the one or more ordered flows until all of the one or more ordered flows are mapped.

4. The NoC of claim 3, wherein the machine learning algorithm is one of a trained supervised learning and unsupervised learning algorithm.

5. The NoC of claim 3, wherein the method further comprises:
for a determination by the machine learning algorithm to postpone the mapping of the current flow, executing a second sorting function on the one or more ordered flows and conducting the mapping based on the one or more ordered flows reordered through the second sorting function.

6. The NoC of claim 1, wherein the utilizing external constraints given by a specification and a design exploration space to map one or more traffic flows on the NoC according to a NoC generation strategy selected among the design exploration space to enforce all possible combinations of the constraints comprises ordering the one or more traffic flows through utilization of a first machine learning algorithm based on the external constraints and a current state of the NoC, wherein the process further comprises:
a) for a first one of the one or more ordered traffic flows, selecting an optimal strategy among the entire design exploration space through a second machine learning algorithm, based on the current state of the NoC;
b) mapping the each of the one or more ordered traffic flows in the NoC using the selected strategy;
c) updating the state of the NoC based on the added first flow;
d) reordering remaining ones of the one or more ordered traffic flows based on the updated state of the NoC and the first machine learning algorithm; and
e) repeat steps a) to d) for each subsequent flow of the one or more ordered flows until all of the one or more ordered flows are mapped.
